(19) United States
(12) Patent Application Publication
(10) Pub. No.: US 2009/0174259 A1
(43) Pub. Date: Jul. 9, 2009

(54) Natural Energy Power Supplying Apparatus

(76) Inventors: Shan-Cheng Lin, Hsinchu City (TW); Szu-Hung Lin, Hsinchu City (TW)

Correspondence Address: HDLS Patent & Trademark Services, P.O. BOX 220746, CHANTILLY, VA, 20153-0746, US

(21) Appl. No.: 11/971,864

(22) Filed: Jan. 9, 2008

(51) Int. Cl. H02J 3/00; H02J 7/02; H02J 1/00; H02J 7/00

(52) U.S. Cl. 307/65; 320/101; 320/137

(57) ABSTRACT

A natural energy power supplying apparatus includes an AC power supply, an inverter, a UPS control circuit, a discharging control circuit, a battery, an electromagnetic switch, a natural energy power supply (NEPS) and a charging control circuit. The inverter is connected to the AC power supply in parallel for converting DC power to AC power. The UPS control circuit is connected to the AC power supply for converting between an AC power and a DC power. The discharging control circuit is connected to the UPS control circuit. The battery is connected to the UPS control circuit and the discharging control circuit respectively. The electromagnetic switch, having multiple normally open switches and multiple normally closed switches, is connected to the AC power supply. The NEPS is connected to the inverter by the normally open switches. The charging control circuit is connected to the NEPS by the normally closed switches, to the battery, to the discharging control circuit, and to the UPS control circuit.

### BACKGROUND OF THE INVENTION

1. Field of the Invention

The present invention relates to a natural energy power supplying apparatus, and more particularly to a natural energy power supplying apparatus that provides uninterruptible electric power by being connected in parallel with an alternating current power supply provided by a regular electricity plant.

2. Description of Related Art

A natural energy power supplying apparatus based on solar energy or wind energy is generally subject to influences of time and weather and suffers from a problem of unstable power output. As a result, such a power supplying apparatus is usually connected in parallel with an alternating current (AC) power supply provided by an electricity plant when supplying power, so as to improve the reliability and the quality of the supplied power.

A natural energy power supplying apparatus as mentioned above usually includes a natural energy power supply such as a solar cell module or a wind power generator, a charger and an uninterruptible power supply (UPS). The charger and the UPS are connected between the natural energy power supply and an AC power supply. The charger includes a charging control circuit and a discharging control circuit. The UPS includes a rectifying circuit and an inverter circuit. A battery is connected to the charger. The inverter is connected in parallel to the AC power supply. The AC power supply is connected to an external load. With such power supplying apparatus, the power generated from the natural energy power supply can be delivered to the AC power supply by going through the UPS and drive the external load. By this means the reliability and the quality of the supplied power is improved and the amount of electricity provided by the AC power supply is reduced so as the cost. In addition, when the natural energy power supply can supply more power than the amount that the external load takes, the natural energy power supply can charge the battery by the charging control circuit. When neither the natural energy power supply nor the AC power supply can supply sufficient power, the battery can supply power to the external load by the discharging control circuit.

The above-mentioned natural energy power supplying apparatus is disclosed such as in Taiwan Parent Pub. No. 1276298. However, when the AC power supply provided by the electricity plant stops working because of a malfunction or other reasons, if the natural energy power supply still works, the power generated by the natural energy power supply will be fed into the AC power supply, which can compromise the safety of any maintenance personnel of the electricity plant. On the other hand, during the time when the AC power supply stops working, if the natural energy power supply is shut off, although the maintenance personnel of the AC power supply can be kept safe, the power supply to the external load is interrupted. Accordingly, the above-mentioned problem needs to be improved.

### SUMMARY OF THE INVENTION

An object of the present invention is to provide a natural energy power supplying apparatus, and more particularly, to provide a circuit that is connected in parallel with a AC power supply between the natural energy power supply and the load, and another circuit that is not connected in parallel with the AC power supply. Controlled by the power supplying status of the AC power supply, the natural energy power supply selects at least one circuit to supply power to the load so as to maintain power supply to the load when the AC power supply stops supplying power and improve the efficiency and the reliability of the natural energy power supplying apparatus.

To achieve the above-mentioned objects, the present invention provides a natural energy power supplying apparatus. The natural energy power supplying apparatus includes an alternating current power supply, an inverter, an uninterruptible power supply control circuit, at least one discharging control circuit, at least one battery, at least one electromagnetic switch, at least one natural energy power supply and at least a charging control circuit. The inverter is connected to the alternating current power supply in parallel for converting direct current power to alternating current power. The uninterruptible power supply control circuit is connected to the alternating current power supply for converting between an alternating current power and a direct current power. The uninterruptible power supply control circuit has an alternating current output port for providing an alternating current to an external load. The at least one discharging control circuit is connected to the uninterruptible power supply control circuit. The discharging control circuit has a direct current output port for providing a direct current to an external load. The at least one battery is connected to the uninterruptible power supply control circuit and the discharging control circuit respectively. The at least one electromagnetic switch is connected to the alternating current power supply and has a plurality of normally open switches and a plurality of normally closed switches. The electromagnetic switch is configured for closing the normally open switches and opening the normally closed switches upon being activated by the alternating current power supply. The at least one natural energy power supply is connected to the inverter by the normally open switches. When the alternating current power supply supplies electric power, power generated by the natural energy power supply is transmitted to the inverter, converted by the inverter and fed into the alternating current power supply. Electric power supplied to the uninterruptible power supply control circuit by the alternating current power supply, after being converted between alternating and direct current power by the uninterruptible power supply control circuit, is ported by the alternating current output port to an external alternating current load for driving the external alternating current load by alternating current, supplied to the battery to charge the battery and supplied to the discharging control circuit. Electric power supplied to the uninterruptible power supply control circuit by the alternating current power supply, after being ported by the direct current output port, is supplied to and thereby drive a direct current load by direct current. The at least one charging control circuit is connected to the natural energy power supply by the normally closed switches, to the battery, to the discharging control circuit, and to the uninterruptible power supply control circuit. When the alternating current power supply does not supply any electric power, electric power generated by the natural energy power supply is supplied to the charging control circuit so as to be controlled by the charging control circuit and used for charging the battery, supplied to the discharging control circuitso as to be ported by the direct current output port to an external direct current load for driving the external direct current load by direct current, and supplied to the uninterruptible power supply control circuitso as to be ported by the alternating current output port to an external alternating current load for driving the external alternating current load by alternating current.

In further embodiments of the present invention, the normally open switch of the electromagnetic switch is defined as point (a) or point (NO), which is non-conducting when the electromagnetic switch is not activated. The normally closed switch of the electromagnetic switch is defined as point (b) or (NC), which is conducting when the electromagnetic switch is not activated. The natural energy power supply is solar cell module or wind power generator.

The uninterruptible power supply control circuit is connected in parallel with the alternating current power supply. The discharging control circuit is connected in parallel with the uninterruptible power supply control circuit. The battery is connected in parallel with the uninterruptible power supply control circuit and the discharging control circuit respectively. The electromagnetic switch is connected in parallel with the alternating current power supply. The charging control circuit is connected in parallel with the uninterruptible power supply control circuit, the battery and the discharging control circuit. The charging control circuit is connected in parallel with the uninterruptible power supply control circuit, the battery and the discharging control circuit, respectively.

In the preferred embodiments, there are a number of natural energy power supply. Each natural energy power supply is connected in series with the inverter, or alternatively, is connected in parallel with the charging control circuit.

Other advantages and novel features will be drawn from the following detailed description of preferred embodiment with the attached drawings, in which:

### BRIEF DESCRIPTION OF THE DRAWINGS

FIG. 1 is a schematic view of a natural energy power supplying apparatus in accordance with a preferred embodiment of the present invention;

FIG. 2 is a schematic view of a natural energy power supplying apparatus of FIG. 1 in a working status;

FIG. 3 is a schematic view of a natural energy power supplying apparatus of FIG. 1 in another working status;

FIG. 4 is a schematic view of a natural energy power supplying apparatus of FIG. 1 in still another working status;

### DETAILED DESCRIPTION OF THE INVENTION

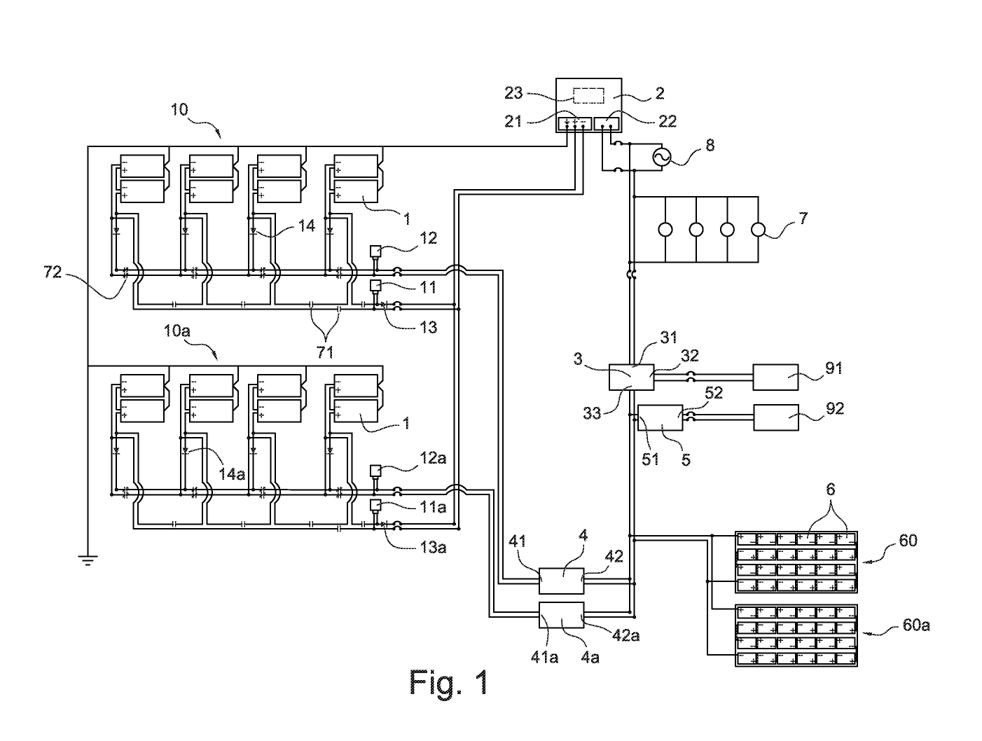

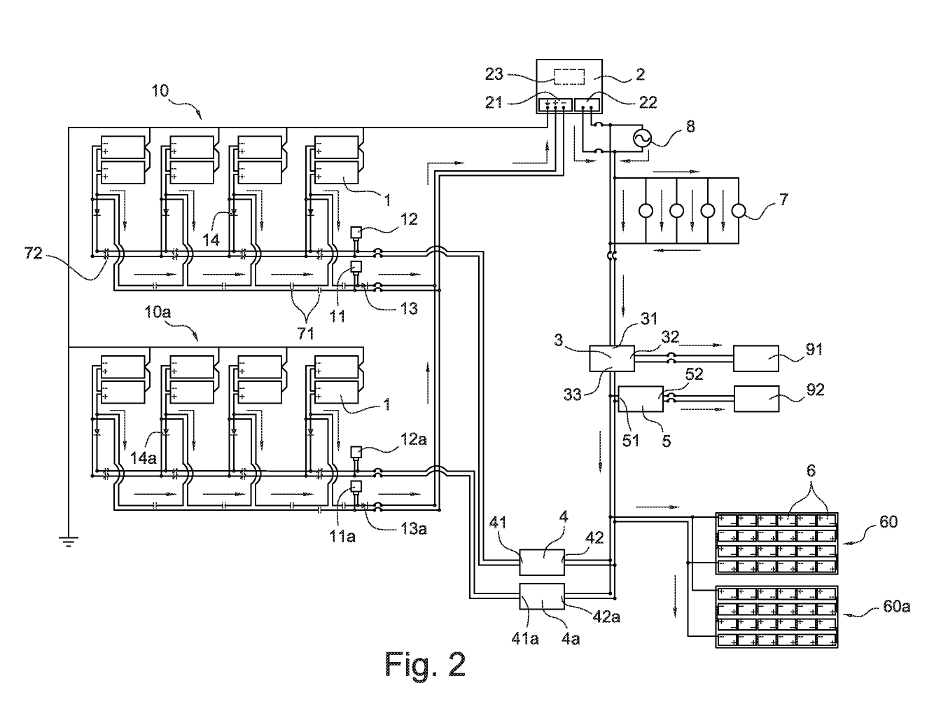

Referring to FIG. 1, a schematic view of the natural energy power supplying apparatus of a preferred embodiment of the present invention is shown. FIG. 2 to FIG. 4 show schematic views of the natural energy power supplying apparatus of FIG. 1 in various working statuses. The arrow in the figures denotes the current flowing direction.

Referring to FIG. 1, the natural energy power supplying apparatus of the preferred embodiment comprises:

an alternating current (AC) power supply 8, which is a supplying end of an electricity plant;

an inverter 2, comprising a rectifying circuit and an inverter circuit, for converting direct current to alternating current, the inverter 2 having a direct current input port 21 and an alternating current output port 22, and being connected to the AC power supply 8 by the alternating current output port 22;

an uninterruptible power supply (UPS) control circuit 3, comprising a rectifying circuit and an inverter circuit, for converting direct current to alternating current or converting direct alternating current to direct current, the UPS control circuit 3 having an alternating current input port 31, an alternating current output port 32 and a direct current output port 33, the UPS control circuit 3 being connected to the AC power supply 8 in parallel via the alternating current input port 31, the alternating output 32 being configured for supplying alternating current to an external alternate current load 91;

at least one discharging control circuit 5, comprising a direct current input port 51 and a direct current output 52, the discharging control circuit 5 being connected in parallel to the direct current output 33 of the UPS control circuit 3 via the direct current input port 51, the direct current output 52 being configured for supplying direct current to an external direct current load 92;

at least one deep cycle battery 6 being connected in parallel with the direct current output port 33 of the UPS control circuit 3 and the direct current input port 51 of the discharging control circuit 5, respectively;

at least one electromagnetic switch 7, in this embodiment for example, multiple electromagnetic switches 7, being connected in parallel to the AC power supply 8, each of the electromagnetic switches 7 having a normally open switch 71 and a normally closed switch 72. When the electromagnetic switch 7 is not activated, the normally open switch 71 is off (non-conducting) and the normally closed switch 72 is on (conducting). When the electromagnetic switch 7 is activated by the AC power supply 8, the normally open switch 71 is on (conducting) and the normally closed switch 72 is off (non-conducting);

at least one natural energy power supply 1 being connected to the normally open switch 71 in series and to the direct current input port 21 in parallel, and being connected to in series with the direct current input port 21 of the inverter 2 via the normally open switch 71; and

at least one charging control circuit 4, in this embodiment for example, two charging control circuit 4 and 4a respectively having a direct current input port 41, 41a and a direct current output port 42, 42a, the direct current input ports 41, 41a being respectively connected in parallel to the natural energy power supply 10, 10a by the normally closed switches 72, the direct current output ports 42a, 2b of the charging control circuit 4 and 4a being respectively connected in parallel with the batteries 60, the direct current input port 51 of the discharging control circuit 5 and the direct current output port 33 of the UPS control circuit 3.

In the preferred embodiment, two groups of batteries 60, 60a each has the same number of the deep cycle batteries 6, which connects one another in series.

In the preferred embodiment, a plurality of natural energy power supplies 1 is provided and separated into two groups of batteries 10 and 10a being connected to each other in parallel. Each group of the batteries 10, 10a connects the normally open switches 71 of the electromagnetic switches 7 in series, and connects the closed switches 72 in parallel. Each group of the batteries 10, 10a connects the inverter 2 via the direct current input port 21 via the normally open switches 71.

In the preferred embodiment, the UPS control circuit 3 and the deep cycle batteries 6 are uninterruptible power supplies, which can be readily acquired from the market. The charging control circuit 4a, 4b and the discharging control circuit 5 are charging/discharging controller, which can also be readily acquired from the market. The charging/discharging controller can be put on a charging mode so as to use the charging control circuit 4, 4a, or be put on a load mode so as to use the discharging control circuit 5. The natural energy power supply 1 can be a solar cell module or a wind power generator.

In this embodiment, the inverter 2 comprises at least one maximum power point tracking device 23 being connected to the natural energy power supply 1, for point tracking and controlling the maximum power of the batteries 10, 10a, so as to enable the inverter 2 to have the capability of maintaining the maximum power point tracking, and to enable the solar cell module and wind power generator to supply the maximum power under various conditions of light illumination or wind speed. In the preferred embodiment, the maximum power point tracking device 23 may be a digital signal processor.

In the embodiment, DC Lightning Arrestors 11 and 11a are respectively connected in parallel between the batteries 10, 10a and the direct current input port 21 of the inverter 2. DC Lightning Arrestors 12 and 12a are respectively connected in parallel between the natural energy power supply 10, 10a and the direct current input port 41, 41a of the charging control circuit 4a, 4b. The DC Lightning Arrestors 11, 11a, 12, and 12a are capable of absorbing harmonic waves generated in circuits for improving quality of the power supplied and protecting the natural energy power supply 1. Diodes 13, 13a are respectively connected in series between the batteries 10, 10a and the direct current input port 21 of the inverter 2, for protecting the natural energy power supply 1. Diode 14, 14a are respectively connected in series between the natural energy power supplies 1 and the direct current input port 41, 41a, so as to prevent current reversely flowing from the direct input port 41, 41a of the charging control circuits 4a, 4b to the energy power supplies 1 and thereby protecting the natural energy power supply 1.

Referring to FIG. 2, the electromagnetic switch 7 can be activated when supplied power by the AC power supply 8. In this case, the natural energy power supply 10 and 10a are respectively switched to be connected with the direct current input port 21 of the inverter 2. Now, the direct current generated from the batteries 10, 10a flows to the inverter 2 and is converted to alternating current by inverted by the inverter 2 so as to be fed to the AC power supply 8 via the alternating current output port 22. The alternating current supplied to the alternating current input port 31 of the uninterruptible power control circuit 3 by the AC power supply 8, after being converted to direct current by the uninterruptible power control circuit 3, is ported by the alternating current output port 32 to drive an external AC load 91, ported by the direct current output port 33 to charge the batteries 60 and 60a, and supplied to the direct current input port 51 of the discharging control circuit 5 so as to be ported by the DC output port 52 to drive an external DC load 92.

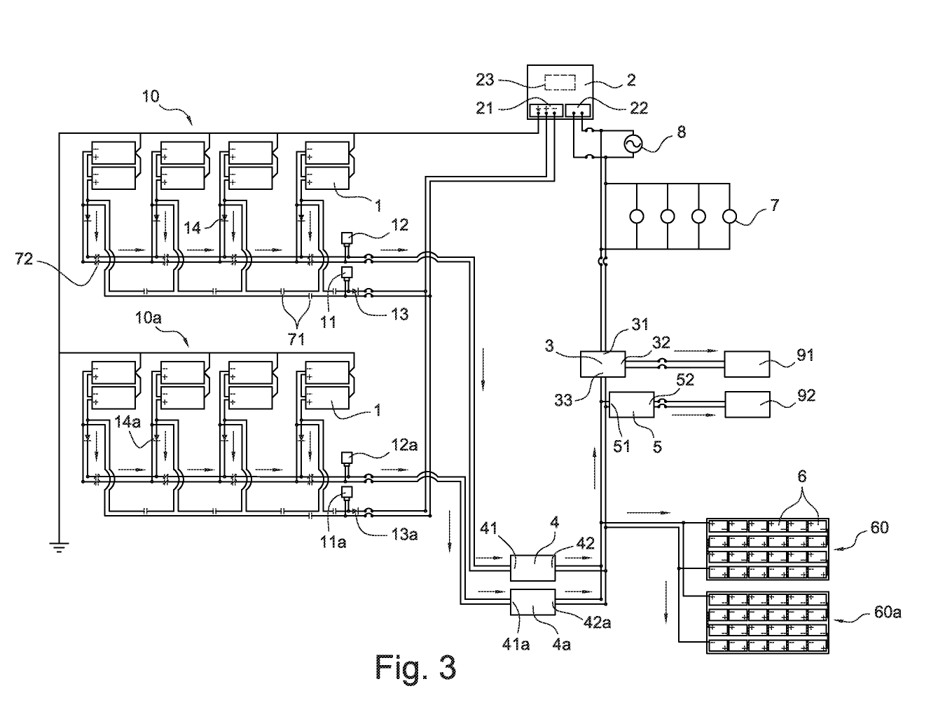

Referring also to FIG. 3, when the power is not provided to the AC power supply 8, the electromagnetic switch 7 is not activated. In this case, the natural energy power supply 10 and 10a are respectively switched to be connected with the DC input port 41 and 41a of the charging control circuit 4 and 4a. Now, the direct current generated by the natural energy power supply 10 and 10a is supplied to the charging control circuit 4 and 4a respectively, controlled thereby in voltage or current, and output by the DC output port 42 and 42a. This DC output can be used to charge the batteries 60 and 60a, supplied to the DC output port 51 of the discharging control circuit 5 so as to be ported by the DC output port 52 to drive an external DC load 92 and supplied to the DC output port 33 of uninterruptible power supply control circuit 3 so as to be ported by the AC output port 32 to drive an external AC load 91.

As described above, among the natural energy power supplies 10, 10a, the loads 91, 92 and the batteries 60, 60a, a circuit that can be connected in parallel with the AC power supply 8 is built and so is another circuit that can not. By using the power supplying status of the AC power supply to control the natural energy power supplies 10 and 10a to select at least one circuit from the above to drive the loads 91 and 92 and charge the batteries 91, 92, the objective of uninterruptedly supplying power to the loads 91 and 92 when the AC power supply stops supplying power is achieved. As a result, the efficiency and the reliability of the natural energy power supplying apparatus is improved.

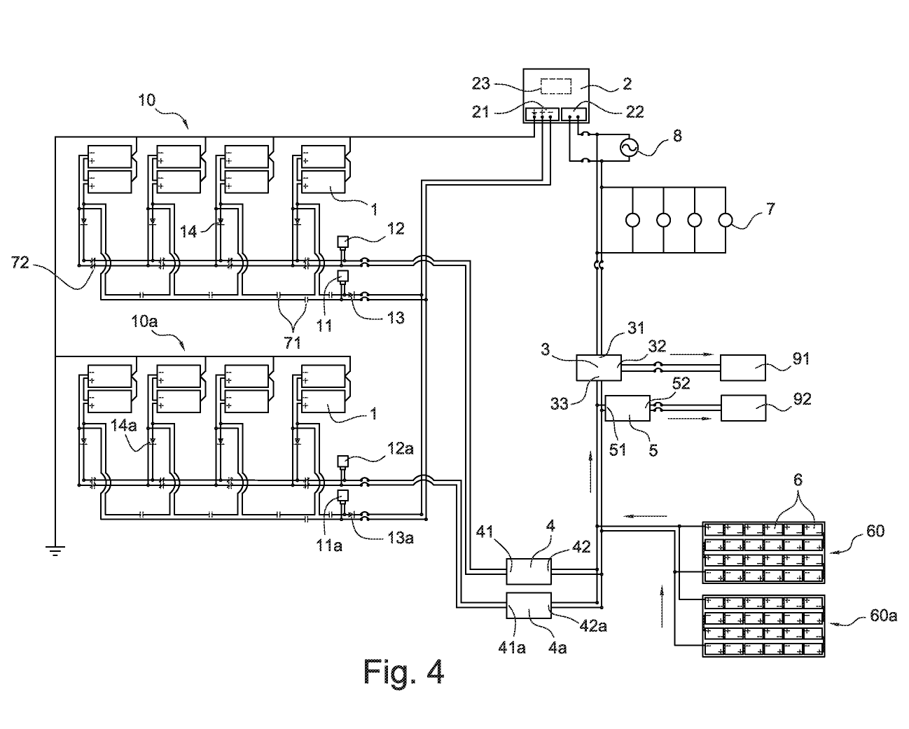

In addition, when the natural energy power supplies 10 and 10a and the alternating current power supply 8 do not supply any electric power (shown in FIG. 4 ), the batteries 60 and 60 can supply DC to the direct current input port 51 of the discharging control circuit 5. The DC, after being controlled by the discharging control circuit 5 in voltage or current, is ported by the DC output port 52 to drive the external DC load 92. The DC can also be supplied to the DC output port 33 of the interruptible power supply control circuit 3, so as to be ported by the AC output port to drive the AC load 91.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

What is claimed is:

1. A natural energy power supplying apparatus, comprising:
an alternating current power supply;
an inverter connected to the alternating current power supply in parallel for converting direct current power to alternating current power;
an uninterruptible power supply control circuit connected to the alternating current power supply for converting between an alternating current power and a direct current power, the uninterruptible power supply control circuit having an alternating current output port for providing an alternating current to an external load;
at least one discharging control circuit connected to the uninterruptible power supply control circuit, the discharging control circuit having a direct current output port for providing a direct current to an external load;
at least one battery connected to the uninterruptible power supply control circuit and the discharging control circuit respectively;
at least one electromagnetic switch being connected to the alternating current power supply and having a plurality of normally open switches and a plurality of normally closed switches, the electromagnetic switch being configured for closing the normally open switches and opening the normally closed switches upon being activated by the alternating current power supply;
atural energy power supply connected to the inverter by the normally open switches, wherein when the alternating current power supply supplies electric power, power generated by the natural energy power supply is transmitted to the inverter, converted by the inverter and fed into the alternating current power supply, electric power supplied to the uninterruptible power supply control circuit by the alternating current power supply, after being converted between alternating and direct current power by the uninterruptible power supply control circuit, is ported by the alternating current output port to an external alternating current load for driving the external alternating current load by alternating current, supplied to the battery to charge the battery and supplied to the discharging control circuit, and electric power supplied to the uninterruptible power supply control circuit by the alternating current power supply, after being ported by the direct current output port, is supplied to and thereby drive a direct current load by direct current; and
at least one charging control circuit being connected to the natural energy power supply by the normally closed switches, to the battery, to the discharging control circuit, and to the uninterruptible power supply control circuit, wherein when the alternating current power supply does not supply any electric power, electric power generated by the natural energy power supply is supplied to the charging control circuit, being controlled by the charging control circuit and used for charging the battery, supplied to the discharging control circuit, being ported by the direct current output port to an external direct current load for driving the external direct current load by direct current, and supplied to the uninterruptible power supply control circuit, being ported by the alternating current output port to an external alternating current load for driving the external alternating current load by alternating current.

2. The natural energy power supplying apparatus as described in claim 1, wherein the uninterruptible power supply control circuit is connected in parallel with the alternating current power supply.

3. The natural energy power supplying apparatus as described in claim 1, wherein the discharging control circuit is connected in parallel with the uninterruptible power supply control circuit.

4. The natural energy power supplying apparatus as described in claim 1, wherein the battery is connected in parallel with the uninterruptible power supply control circuit and the discharging control circuit respectively.

5. The natural energy power supplying apparatus as described in claim 1, wherein the electromagnetic switch is connected in parallel with the alternating current power supply.

6. The natural energy power supplying apparatus as described in claim 1, wherein there are a plurality of natural energy power supply, each natural energy power supply being connected in series with the inverter.

7. The natural energy power supplying apparatus as described in claim 1, wherein there are a plurality of natural energy power supply, each natural energy power supply being connected in parallel with the charging control circuit.

8. The natural energy power supplying apparatus as described in claim 1, wherein the natural energy power supply is a solar cell module or a wind power generator.

9. The natural energy power supplying apparatus as described in claim 1, wherein the charging control circuit is connected in parallel with the uninterruptible power supply control circuit, the battery and the discharging control circuit respectively.
